(19) United States
(12) Patent Application Publication
(10) Pub. No.: US 2009/0144641 A1
(43) Pub. Date: Jun. 4, 2009

(54) LIQUID CRYSTAL DISPLAY AND DISPLAY SYSTEM COMPRISING SAME

(76) Inventors: Myeong-su KIM, Cheonan-si (KR); Jang-hyun YEO, Seoul (KR)

Correspondence Address: Haynes and Boone, LLP;IP Section, 2323 Victory Avenue, SUITE 700, Dallas, TX, 75219, US

(21) Appl. No.: 12/234,953

(22) Filed: Sep. 22, 2008

(30) Foreign Application Priority Data
Dec. 3, 2007 (KR) 10-2007-0124521

(51) Int. Cl. G06F 3/048

(52) U.S. Cl. 715/763

(57) ABSTRACT

A liquid crystal display (LCD) monitor having an LCD screen is provided in a display system where the monitor is coupled to a host device by way of serial data links such as VESA DisplayPort links. The LCD monitor uses a first bi-directional serial channel (e.g., AUX_CH) to send an OSD (on-screen display) image-requesting control signal to the host device. The host device uses a first unidirectional serial channel (e.g., Main link) to return a corresponding OSD video signal to the monitor. The monitor includes a handling portion for providing a user command signal in response to user manipulation of on-monitor inputs, and a timing controller for receiving the user command signal and outputting a corresponding OSD image-requesting control signal through the first bi-directional channel to the host device. The timing controller receives the corresponding OSD video signal from the host and produces a corresponding OSD image on the LCD screen.

### CROSS-REFERENCE TO RELATED APPLICATION

This application claims priority from Korean Patent Application No. 10-2007-0124521 filed on Dec. 3, 2007 in the Korean Intellectual Property Office, the disclosure of which is incorporated herein by reference in its entirety.

### BACKGROUND

1. Field of Disclosure

The present disclosure of invention relates to a liquid crystal display (LCD) monitor and a combined computer-display system including the same.

2. Description of Related Technology

An LCD based video monitor receives video signals from an external host device, and after processing the supplied signals, displays predetermined images in accordance with the processed video signals. By way of example, an LCD monitor may receive DVI (Digital Visual Interface) signals and analog signals from a computer, and after performing conversion of the signals into LVDS (Low Voltage Differential Signaling) signals, processes the converted LVDS signals so as to display predetermined images.

A so-called DisplayPort (DP) interface standard has been recently put forth by the Video Electronics Standards Association (VESA) to replace older computer-to-monitor interfaces. Under the older standards the display monitor was generally responsible for displaying monitor control visuals (On Screen Control visuals) such as those that indicate screen brightness, screen contrast, frame positioning, etc. One aspect of LCD monitors that is not common with older CRT-based display units is that screen brightness is typically controlled by controlling intensity of backlighting light provided by a local backlight unit.

### SUMMARY

The present disclosure provides a liquid crystal display (LCD) monitor having an OSD (On-Screen Display) capability that can interact with the VESA-DP function.

Another aspect of the present disclosure is that it provides a display system having an OSD function.

However, the aspects of the present disclosure are not restricted to those set forth herein. The above and other aspects of the present disclosure will become apparent to one of ordinary skill in the art to which the present disclosure pertains by referencing the detailed description as given below.

According to an aspect of the present disclosure, there is provided a liquid crystal display (LCD) monitor including: a first bi-directional channel; a first unidirectional channel; a handling portion for providing a user command signal in response to user input manipulations; and a timing controller for receiving the user command signal and outputting to an external host device, an OSD (On-Screen Display) control request signal through the first bi-directional channel, and receiving a responsive OSD video signal corresponding to the OSD control request signal through the first unidirectional channel from the external host device.

According to another aspect of the present disclosure, there is provided a display system including: an LCD including a handling portion for providing a user command signal in response to user manipulation of user actuatable inputs, and a timing controller for receiving the user command signal and outputting an OSD control request signal, and receiving a responsive OSD video signal; and a host device for receiving the OSD control request signal, and providing the responsive OSD video signal in a manner corresponding to the OSD control request signal to the LCD.

### BRIEF DESCRIPTION OF THE DRAWINGS

The above and other aspects and features of the present disclosure will become apparent by describing in detail exemplary embodiments thereof with reference to the attached drawings, in which:

FIG. 1 is a schematic view of a display system which includes an exemplary liquid crystal display (LCD) monitor structured according to the present disclosure;

FIG. 2 is a block diagram for describing the display system and the LCD monitor included therein of FIG. 1;

FIG. 3A is a schematic diagram for describing an LCD and a display system comprising the same according to one embodiment of the present disclosure;

FIG. 3B is a front view of the LCD of FIG. 3A;

FIG. 3C is a schematic diagram for describing an interface between an LCD and a host device;

FIG. 3D is a sectional view of a transmission cable of FIG. 3A; and

FIG. 4 is a schematic diagram for describing an LCD and a display system comprising the same according to another embodiment.

### DETAILED DESCRIPTION

The disclosure will now be described more fully hereinafter with reference to the accompanying drawings, in which exemplary embodiments in accordance with the present disclosure are illustrated. The disclosure may, however, be implemented in different forms and should not be construed as limited to the specific embodiments set forth herein. Rather, these embodiments are provided so that this disclosure conveys a fuller scope of appreciation of the disclosed concepts to those skilled in the art.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers denote like elements throughout the specification. As used herein the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure most closely pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

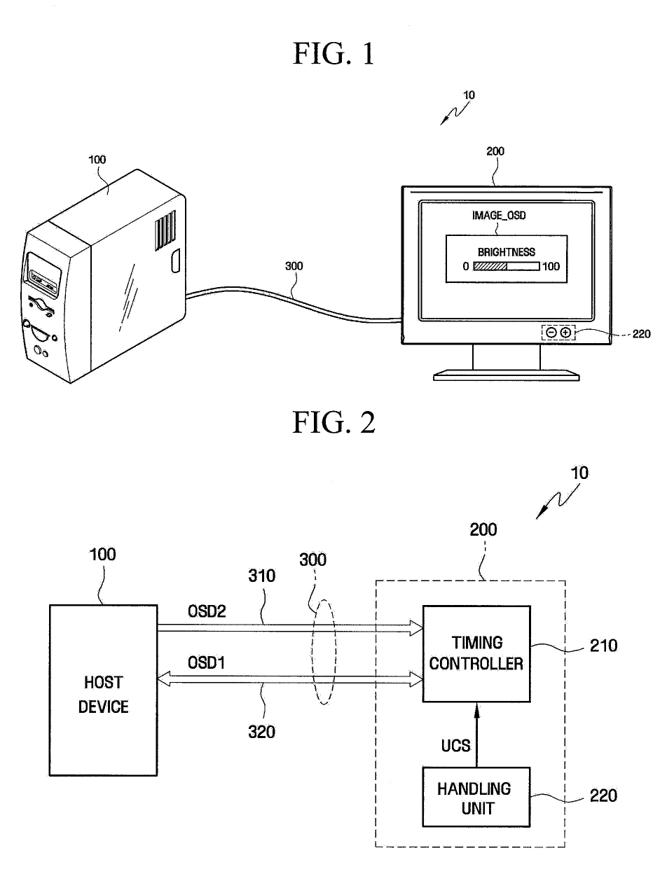

A liquid crystal display (LCD) and a display system according to embodiments of the present disclosure will hereinafter be described in detail with reference to FIGS. 1 and 2. FIG. 1 is a schematic view of a display system which includes a liquid crystal display (LCD) according to embodiments of the present disclosure, and FIG. 2 is a block diagram for describing the display system and the LCD included therein of FIG. 1.

Referring first to FIG. 1, a display system 10 according to the present disclosure includes an LCD monitor 200, a host device (e.g., computer) 100 that is external of the LCD monitor, and a VESA-DP compatible transmission cable 300 interconnecting the LCD monitor 200 and the host device 100. The transmission cable 300 may include unidirectional and bi-directional signal transmission channels in accordance with the VESA-DP standard.

The LCD monitor 200 interfaces with the host device 100 through the transmission cable 300. As an example, the LCD monitor 200 receives video signals and/or audio signals from the host device 100 via a unidirectional channel (e.g., MAIN link channel) of the transmission cable 300. Further, the LCD monitor 200 may transmit an OSD (on-screen display) requesting control signal to the host device 100 via a bi-directional channel (e.g., VESA-DP AUX channel) of the transmission cable 300. In response, the host device 100 provides an OSD video signal to the LCD monitor 200 via the unidirectional channel of the transmission cable 300. The LCD monitor 200 then processes the received OSD video signal and displays a corresponding OSD image (IMAGE_OSD).

Referring to FIG. 2, in one embodiment, the LCD monitor 200 includes a timing controller 210 and a handling portion 220.

As an example, the handling portion 220 may include user-actuatable buttons disposed on a front portion of the LCD monitor 200 as shown by the + and − buttons at 220 in FIG. 1. The handling portion 220 generates a user command signal (UCS) in accordance with user manipulation of the front panel buttons. As an example, in order to adjust the brightness or contrast of the LCD monitor 200, the user may press the buttons of the handling portion 220 in order to indicate the user is requesting a change of brightness, in response to which the handling portion 220 provides a corresponding user command signal (UCS) to the timing controller 210.

The timing controller 210 receives the user command signal (UCS) and outputs a corresponding OSD requesting control signal (OSD1) to the host device 100. To be more precise, the timing controller 210 outputs the OSD requesting control signal (OSD1) to the host device 100 through a bi-directional channel 320 (e.g., AUX channel) of the transmission cable 300.

As shown in FIG. 2, the host device 100 provides a corresponding OSD video signal (OSD2) to the LCD monitor 200 in response to the requesting signal OSD1 so that the requested OSD image (IMAGE_OSD) may be displayed on a screen of the LCD monitor 200. A program may be stored in the host device 100 for generating the requested OSD image (IMAGE_OSD) before the image is displayed on the screen of the LCD monitor 200. The host device 100 provides the requested OSD video signal (OSD2) to the timing controller 210 through a unidirectional channel 310 of the transmission cable 300.

In summary, the LCD monitor 200 exchanges request and response signals via cable 300 with the external host device 100 in order to cause display of an appropriate OSD image (IMAGE_OSD) on the monitor screen corresponding to what the user requested via the user interface handling portion 220. A computer program for determining what to display, if at all, as the requested OSD image (IMAGE_OSD) and its background is not contained in the LCD monitor 200; but rather is included in the external host device 100. Accordingly, the manufacturer of the host device 100 has great flexibility in determining what the OSD image and/or its background will look like and/or what the look and feel of the user interactions with the display control buttons 220 will be. For example, in some applications the host device 100 may intentionally disable certain user-actuatable monitor control options as deemed appropriate.

In terms of greater detail, in response to user input manipulations of the on-LCD user interface (220), the LCD monitor 200 outputs the corresponding OSD requesting control signal (OSD1) corresponding to the user command signal (UCS) to the host device 100 via bidirectional channel 320. In response to the OSD requesting control signal (OSD1) received from the LCD 200, the external host device 100 provides the corresponding OSD video signal (OSD2) to the LCD monitor 200 via unidirectional channel 310, and the LCD monitor 200 then displays the host-generated OSD image (IMAGE_OSD) in accordance with the OSD video signal (OSD2) provided from the host device 100 via unidirectional channel 310.

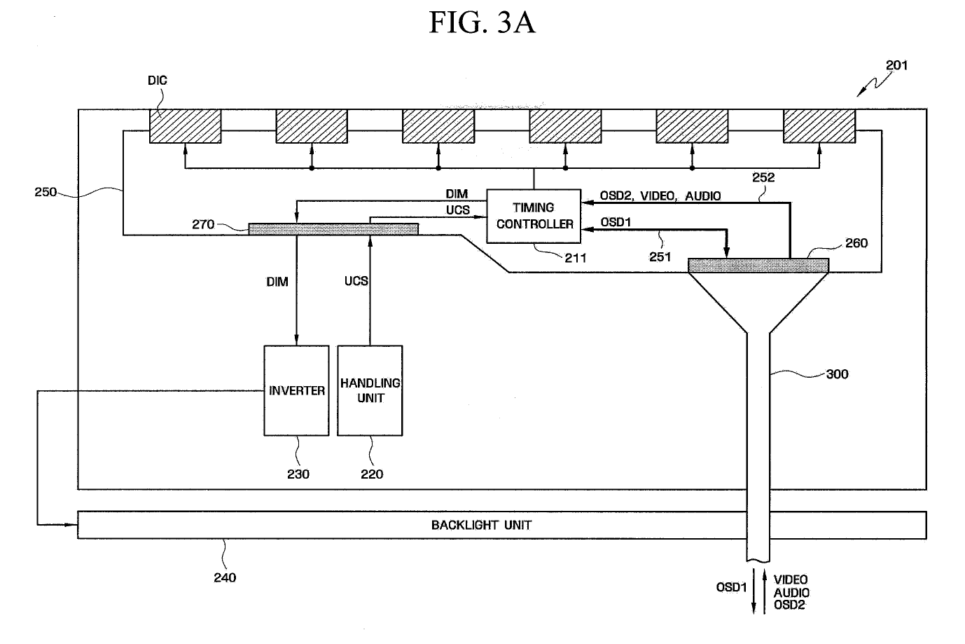

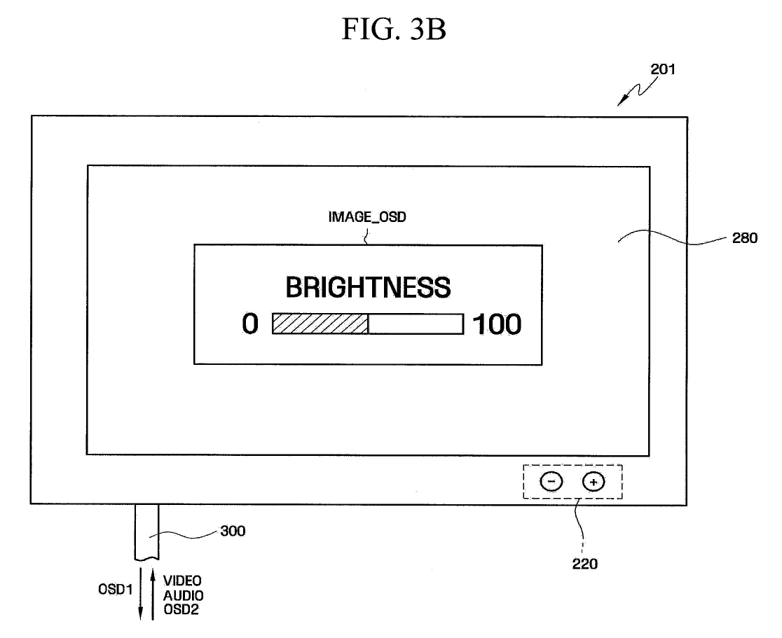

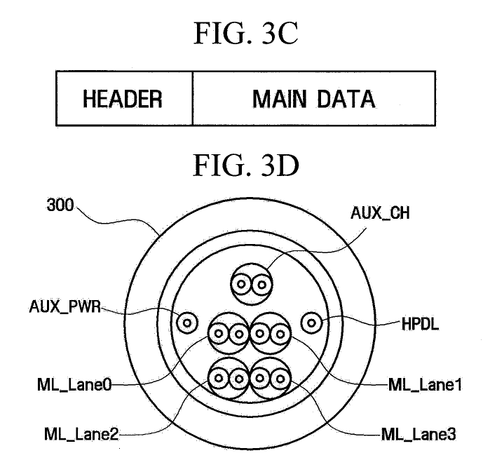

Various embodiments of an LCD and a display system comprising the same and in accordance with the present disclosure will be described hereinafter. The LCD in each embodiment is described as interfacing with the host device utilizing the VESA DisplayPort standard. However, the present disclosure is not limited in this respect. Other display interfaces that have bidirectional and unidirectional channels may be used. The VESA DisplayPort is a digital display interface standard put forth by VESA (Video Electronics Standards Association), a description of which is publicly available to those skilled in the art and thus will not be provided in detail herein. (See however, FIG. 3D which shows a four lane, main link configuration.)

An LCD and a display system comprising the same according to one embodiment of the present disclosure will hereinafter be described with reference to FIGS. 3A to 3D. FIG. 3A is a conceptual schematic diagram for describing an LCD monitor 201 within a display system (10, not fully shown) comprising the same and an external host device according to one embodiment. FIG. 3B is a front view of the LCD monitor 201 of FIG. 3A showing a possible OSD image (e.g., Brightness control) displayed on the LCD monitor 201 but originated from, defined by and controlled (varied) by software executing in the host device (e.g., 100 of FIG. 1). FIG. 3C is a schematic diagram for describing an interfacing data structure between an LCD and a host device. FIG. 3D is a cross sectional view of the transmission cable 300 of FIG. 3A when configured according to the VESA DP standard.

Referring to FIGS. 3A and 3B, an LCD 201 interfaces with an external host device (100, not shown) via a first VESA-DP compatible connector 260 and a VESA-DP compatible transmission cable 300 connected to the first connector 260. As an example, the LCD 201 may interface with the host device through use of the DisplayPort standard interface connector. The LCD 201 receives a video signal (VIDEO) and/or an audio signal (AUDIO) from the host device (not shown) via serial signals transmitted through the first connector 260 and the transmission cable 300 connected thereto. In response to user manipulation of user inputs such as user manipulatable buttons 220 (FIG. 3B), the LCD 201 outputs a corresponding OSD requesting control signal (OSD1) to the host device (not shown) through the first connector 260 and through the transmission cable 300 connected thereto. The LCD 201 receives whatever responsive OSD video signal (OSD2) the host device decides to send from the host device (not shown) also over the interconnect cable 300 and through the first connector 260. A timing controller 211 receives the responsive OSD video signal (OSD2) and displays a corresponding OSD image (IMAGE_OSD) on a liquid crystal panel 280 of the monitor 200.

Further, the timing controller 211 of the LCD 201 is able to interface with internal modules of the LCD through a second disconnectable connector 270. As an example, the timing controller 211 of the LCD 201 may receive a user command signal (UCS) from a handling portion 220 through the second connector 270, and may provide a dimming signal (DIM) for controlling the brightness of an LCD backlighting unit 240 to an inverter 230 through the second connector 270. Such dimming may allow the system to conserve power as it waits for example, for response inputs from a user. In other words, the LCD may go into a low power idle state if no interactions from a host or a user are received after a predetermined wait time. In this low power idle state, the backlight unit 240 may be dimmed to a predefined idle state so as to save energy and increase lifetime of light emitters (e.g., fluorescent bulbs) of the backlight unit 240. If and when interaction is detected from a host or a user, the predefined idle state is halted and the backlight unit 240 resumes whatever DIM state it was last commanded to be in.

In the following, each module of one embodiment is described in greater detail. The LCD 201 includes the liquid crystal panel 280 whose image is projected in part by light provided from the backlighting unit 240. The LCD 201 further includes a circuit substrate 250 (e.g., printed circuit board or PCB), the timing controller 211 implemented as a monolithic integrated circuit (IC) mounted on the substrate 250, a gate driver IC (not shown), a plurality of data driver IC's (DIC), a backlight powering inverter 230, the user-input handling portion 220, and the backlight unit 240. As will be understood by those skilled in the LCD arts, the DIC's couple to data drive lines on a TFT's-containing transparent substrate of the LCD panel 280. The data lines are crossed by gate lines and bounded regions of these crossings define pixel areas on the LCD screen 280.

The liquid crystal panel 280 displays images utilizing a configuration that includes a plurality of gate lines (mentioned above but not shown), a plurality of data drive lines (mentioned above but not shown), and a plurality of pixel areas (not shown) formed at regions of intersection of the plurality of gate lines (not shown) and the plurality of data lines (not shown).

The gate driver IC (not shown) and the data driver IC's (DIC's) are coupled to the liquid crystal panel 280 via a typically flexible ribbon cable (not fully shown, but understood to extend from the top edge of circuit substrate 250 in FIG. 3A) in order to cause display of images. In one embodiment, the data driver IC's (DIC's) and the gate driver IC (not shown) may be both mounted directly on the liquid crystal panel 280 rather than on the circuit substrate 250. However, the configurations and/or connections of the data line driver ICs (DIC's) and the gate driver IC(s) (not shown) are not limited in this regard.

Further circuits (not shown) may be mounted on the circuit substrate 250 for generating various signals for driving the timing controller 211 and the LCD 201. A plurality of wires or PCB traces may be formed on the circuit substrate 250 for electrically interconnecting the timing controller 211, the data driver IC(s) (DIC(s)), and the various other circuits (not shown). Further, the circuit substrate 250 includes the first lo disconnectable connector 260 and the second disconnectable connector 270, and may include means for implementing the bi-directional channel 251 (e.g., AUX channel) and the unidirectional channel 252 (e.g., Main Link) for thereby electrically interconnecting the first connector 260 and the timing controller 211. In one embodiment, each of the bi-directional channel 251 and the unidirectional channel 252 is defined by one or more serial data links. More specifically (see FIG. 3D), the VESA-DP interface uses four serial data links referred to as main-link lanes 0 to 3 for unidirectionally carrying video display data and audio data; and a fifth serial data link referred to as the Auxiliary channel (AUX) for bidirectionally carrying AUX_CH signals.

Referring still to FIG. 3A, the first connector 260 disconnectably interconnects the LCD 201 and the external host device (not shown) to one another with use of disconnectable cable 300. The second connector 270 disconnectably interconnects the timing controller 211 and the off-substrate internal modules (e.g., 220, 230) to one another. In one embodiment, the first connector 260 may have 20 pins arranged in order to realize standardized interfacing in accordance with the VESA DisplayPort standard which is publicly put forth by the VESA organization (VESA.org). According to the DisplayPort interface standard established by VESA, the first connector 260 has a fixed design and may not thus provide pins for allowing interfacing of the timing controller 211 with the internal LCD modules (e.g., 220, 230). For this purpose, the circuit substrate 250 includes the second connector 270 so that the timing controller 211 may modularly interface with the internal modules.

Internal modules such as the inverter 230 and the handling portion 220 of FIG. 3A may be coupled to the timing controller 211 by way of the disconnectable second connector 270. Although the inverter 230 and the handling portion 220 are provided as examples of such internal modules, the present disclosure is not limited in this regard and allows for alternative or additional internal modules. As additional examples of internal modules, a sound output device such as a loud speaker, and a USB terminal coupled to a USB memory may be coupled to the second connector 270.

The handling portion 220 is coupled to the second connector 270 so as to interface with the timing controller 211. The handling portion 220 provides a user command signal (UCS), which corresponds to user manipulation of user-actuatable inputs that couple to the handling portion 220. The user command signal (UCS) couples to the timing controller 211 via the second connector 270. The user command signal (UCS) may be a signal that requests control of the On/Off states of the backlight unit 240, which seeks to adjust the brightness of the backlight unit 240, or seeks to adjust the picture size or contrast of the image displayed on the liquid crystal panel 280. In other words, the user command signal (UCS) is a signal requesting to control operations such as those of the internal modules, and more specifically such as operations of the backlight unit 240.

The inverter 230 is coupled to the second connector 270 so as to interface with the timing controller 210. The inverter 230 receives a dimming control signal (DIM) for adjusting the brightness of the backlight unit 240 from the timing controller 211 through the second connector 270. The inverter 230 receives the dimming control signal (DIM) and responsively adjusts the brightness of light output by the backlight unit 240 accordingly.

As mentioned, the timing controller 211 interfaces with the off-board LCD internal modules through the second connector 270. That is, the timing controller 210 receives a user command signal (UCS) from the handling portion 220 through the second connector 270, and if the UCS is one that is requesting user control of the screen brightness or user control of the screen On/Off function, the timing controller 211 ultimately outputs a corresponding module control signal (e.g., the dimming signal (DIM) for adjusting the brightness of the backlight unit 240) through the second connector 270. By ultimately, it is meant here that the timing controller 211 may not necessarily immediately output a changed dimming signal (DIM) to inverter 230. Instead, the timing controller 211 may first wait for an OSD image selected by the host to be displayed and for additional user input manipulation to occur. For example, if the user seeks to control image brightness by reducing brightness to less than 50%, timing controller 211 may first wait for brightness control OSD image shown in FIG. 3B to appear on screen 280. Then, as the user depresses the minus (−) button, the timing controller 211 may output a correspondingly changed dimming signal (DIM) to inverter 230.

In the illustrated embodiment, however, the timing controller 211 does not include means for directly defining and adjusting the displayed OSD_Image (e.g., the one shown in FIG. 3B). Instead, the timing controller 211 expects the external host device (e.g., 100) to define, generate and adjust the displayed OSD_Image. This host-originated OSD_Image arrives through unidirectional channel 252. In order to inform the external host device (e.g., 100) of the desired OSD_Image, the timing controller 211 interfaces with the host device (not shown) through the on-substrate first bidirectional channel 251 (e.g., AUX_CH) and the transmission cable 300. That is, the timing controller 211 outputs an OSD image requesting control signal (OSD1) corresponding to the local user command signal (UCS) to the host device (not shown) through the on-substrate first bi-directional channel 251 (Main Link), through the first connector 260 and through the transmission cable 300. At this time, the timing controller 211 may transmit to the host device (not shown) an OSD image requesting control signal (OSD1) having a packet data structure such as shown in FIG. 3C. The transmission direction and the type of the main data (MAIN DATA) may be determined from information contained in the packet header (HEADER). That is, the timing controller 211 may indicate in the header (HEADER) that transmission is being directed to the host device (packet destination, not shown) and that the main data (MAIN DATA) is the OSD image requesting control signal (OSD1). Further, the OSD control signal (OSD1) may be transmitted as a portion of the main data (MAIN DATA) rather than as its entirety.

In addition, in accordance with VESA_DP protocol, the timing controller 211 may provide an EDID (Extended Display Identification Data) signal and/or an HDCP (High-bandwidth Digital Content Protection) signal to the host device (not shown) through the first bi-directional channel 251 and the transmission cable 300. Also at this time, the timing controller 211 may indicate by setting of bits in the header (HEADER) that transmission destination is the host device (not shown), and that the main packet data (MAIN DATA) is an EDID signal and/or an HDCP signal. Further, the EDID signal and/or HDCP signal may be transmitted as a portion of the MAIN DATA rather than as its entirety.

Furthermore, the timing controller 211 may receive from the host device (not shown) and through the first bi-directional channel 251, and the transmission cable 300 control signals for controlling output of a video signal (VIDEO) and/or an audio signal (AUDIO). At this time, the host device (not shown) may determine from the packet header (HEADER) of a requesting control signal that transmission is to be performed to the timing controller 211 by the host device (not shown), and that the requested main data (MAIN DATA) is the EDID signal and/or the HDCP signal. Further, the control signals that control the output of the video signal (VIDEO) and/or the audio signal (AUDIO) may be transmitted as part of the main data (MAIN DATA). The EDID and HDCP signals, and the control signals that control the output of the video signal (VIDEO) and/or the audio signal (AUDIO) may comply with the Monitor Control Command Set (MCCS) standard put forth by VESA.

When the requesting control signal (OSD1) output by the timing controller 211 requests a specified OSD_Image, the timing controller 211 receives the requested OSD video signal (OSD2) from the host through the cable 300, the first connector 260 and the first unidirectional channel 252. After receiving the requested OSD video signal (OSD2), the timing controller 211 controls the on-substrate data drivers (DIC's) and the gate driver (not shown) such that the corresponding OSD image (IMAGE_OSD) as determined by software executing in the host device will be displayed. Additionally, the timing controller 211 may receive an accompanying audio signal (AUDIO) from the host device (not shown) through the first unidirectional channel 252.

The transmission cable 300 is disconnectably coupled to the first connector 260 to thereby interconnect the LCD 201 and the host device (not shown). The transmission cable 300, as shown in FIG. 3D, may include one or more bidirectional channels (AUX_CH) and four or more unidirectional channels (ML_Lane0, ML_Lane1, ML_Lane2, ML_Lane3). As an example, the transmission cable 300 may include one differential drive pair of wires for the bi-directional serial data channel (AUX_CH) and four differential drive pairs of wires for the respective four unidirectional serial data channels (ML_Lane0, ML_Lane1, ML_Lane2, ML_Lane3). Also, the transmission cable 300 may further include a hot plug detect line (HPDL) and an auxiliary power line (AUX_PWR) in accordance with the VESA-DP standard.

The in-cable bi-directional channel wires (AUX_CH) are connected to the in-monitor bi-directional channel lines 251 through the first connector 260 and similarly, the in-cable unidirectional channel wires (ML_Lane0, ML_Lane1, ML_Lane2, ML_Lane3) are connected to the in-monitor unidirectional channel lines 252 through the first connector 260. The hot plug detect line (HPDL) and the auxiliary power line (AUX_PWR) may be lines for enabling the LCD 201 to realize further VESA-DisplayPort interfacing functions with the host device (not shown).

In summary, the program and/or device for generating and/or defining the requested OSD image (IMAGE_OSD) is included in the external host device (not shown) rather than in the LCD monitor. Accordingly, the LCD monitor 200 must interface with a responsive external host device (not shown) so as to display OSD images (IMAGE_OSD) requested by the timing controller 211 but originated by the host device. In greater detail and in accordance with embodiment, the LCD monitor 200 interfaces with the host device (not shown) utilizing the DisplayPort standard. In this case, the LCD monitor 200 outputs the OSD image requesting control signal (OSD1) through the bi-directional channel (AUX_CH), and receives the corresponding OSD video signal (OSD2) through a unidirectional channel (Main Link).

Through use of such an LCD and display system, the LCD monitor does not need to include memory devices for storing the software program(s) that define the OSD images and/or hardware devices for supporting display and adjustment of the OSD images (IMAGE_OSD). Therefore, the LCD monitor may be made at lower cost, reduced energy consumption, with a slimmer profile and the internal structure of the LCD monitor may be simplified. Further, the LCD monitor 200, which interfaces with the host device (not shown) utilizing the DisplayPort standard, is provided with OSD functions including that of controlling backlight brightness to thereby enhance the convenience provided to users.

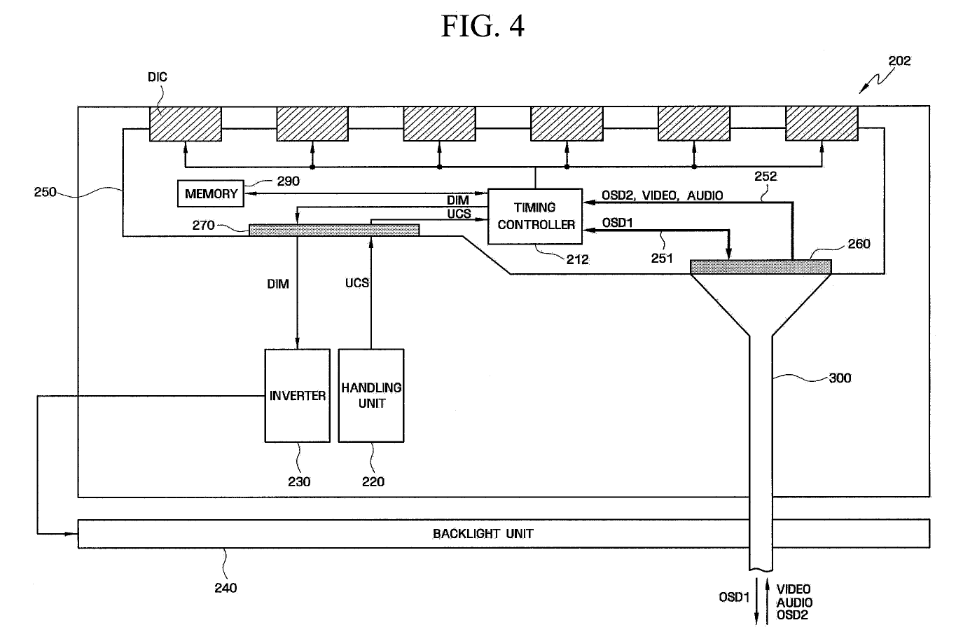

An LCD and a display system comprising the same according to another embodiment of the present disclosure will hereinafter be described with reference to FIG. 4. FIG. 4 is a schematic diagram for describing an LCD and a display system comprising the same according to another embodiment of the present disclosure. Like reference numerals are used for elements of FIG. 4 functioning substantially identically to those illustrated in FIG. 3A, and a detailed description of such elements is not provided herein.

Referring to FIG. 4, unlike the previous embodiment, the LCD monitor 202 of this embodiment further does includes a memory unit 290 outside of and operatively coupled to the timing controller 212. The memory 290 is disposed on the circuit substrate 250 and is connected to the timing controller 212. The memory 290 may store the module control signals for controlling the operations of the LCD internal modules. The memory 290 may include an EEPROM (Electrically Erasable Programmable Read-Only Memory) or a Flash memory region or the like for nonvolatilely but reprogrammably storing control data. Even though memory unit 290 is provided, that memory unit 290 still does not need to store software programs or the like for defining OSD images because the latter images are still imported from the external host device via the unidirectional channel 252 and the latter images are still defined and updated by software programs executing in the external host device.

A more detailed description will be provided hereinafter using the example in which the user manipulates the handling portion 220 to adjust the brightness of the LCD 202.

The handling portion 220 provides a user command signal (UCS) to the timing controller 212 that corresponds to user manipulation. As an example, the user command signal (UCS) is assumed to be a signal for increasing screen brightness.

In response to the user command signal (UCS), the timing controller 212 provides the OSD image-requesting control signal (OSD1) to the host device (not shown) through the first bi-directional channel 251, the first connector 260, and the transmission cable 300. Further, after the external host generates the requested OSD image data, the corresponding OSD video signal (OSD2) is transmitted by the host device (not shown) and is received by the LCD monitor 202 through the transmission cable 300, the first connector 260, and the first unidirectional channel 252. The timing controller 212 process the received OSD video signal (OSD2) and causes the corresponding OSD image (IMAGE_OSD) to be displayed on the LCD screen 280.

In addition, in response to the exemplary user command signal (UCS) requesting an increasing of screen brightness, the timing controller 212 provides a module control signal, e.g., the dimming signal (DIM), to the inverter 230 for causing the inverter to correspondingly increase the backlight intensity. The timing controller 212 may store the latest dimming signal (DIM) value in the nonvolatile memory 290. Thus even if the LCD monitor 202 is turned off and again turned on, the timing controller 212 does not lose track of the last dimming value because on power-up, the timing controller 212 reads the last dimming signal (DIM) value from the memory 290 and provide the corresponding DIM signal to the inverter 230 so as to restore the last screen brightness. That is, even if the LCD 202 is turned off and thereafter turned on, since the memory 290 stores the dimming signal (DIM) corresponding to the last level of brightness desired by the user, the brightness existing prior to turning off the LCD 202 is maintained and the user need not again adjust the brightness of the LCD 202 unless a new brightness is desired.

The memory 290 is able to store each of the internal module control signals or parameters, which are generated in accordance with user manipulation of input means 220. That is, the memory 290 receives (from the timing controller 212) and stores at least the information of the dimming signal (DIM) for controlling the brightness of the backlight unit 240. The memory 290 may additionally receive (from the timing controller 212) and store information representing the last contrast level, information representing the last size of the image displayed on the liquid crystal panel 280, and so forth. When it is requested by the timing controller 212, the memory 290 provides this stored information to the timing controller 212.

The memory 290 and the timing controller 212 may interface with each other via an 12C (Inter-Integrated Circuit) bus. However, the present disclosure is not limited in this regard.

While the present disclosure has been particularly shown and described with reference to exemplary embodiments thereof, it will be understood by those of ordinary skill in the art that various changes in form and details may be made therein without departing from the spirit and scope of the present disclosure.

What is claimed is:

1. A liquid crystal display (LCD) comprising:
a first bidirectional channel and a first unidirectional channel that are connectable to an external host device;
a user inputs handling unit that provides user command signals in response to user manipulation of user actuatable inputs; and
a timing controller for receiving the user command signals and outputting an OSD (On-Screen Display) image-requesting control signal through the first bi-directional channel to an external host device, and receiving a corresponding OSD video signal corresponding to the OSD image-requesting control signal through the first unidirectional channel from the external host device.

2. The LCD of claim 1, wherein the timing controller receives from the external host device an audio signal through the first unidirectional channel.

3. The LCD of claim 1 and further comprising:
a circuit substrate having a disconnectable first connector,
wherein the timing controller and at least part of the first bi-directional channel, and at least part of the first unidirectional channel are disposed on the circuit substrate, and
wherein the on-substrate parts of the first bi-directional channel and the first unidirectional channel are operatively coupled to the first connector to thereby receive or transmit signals through the first connector.

4. The LCD of claim 3, wherein the circuit substrate further comprises a disconnectable second connector, and wherein
the user inputs handling unit provides the user command request signal to the timing controller through the second connector.

5. The LCD of claim 4, and further comprising:
a backlighting unit for generating light; and
an inverter connected via the second connector to the timing controller to receive a dimming signal from the timing controller, where the dimming signal is for controlling brightness of light supplied by the LCD backlighting unit,
wherein the timing controller provides the dimming signal in a manner corresponding to the user command signals.

6. The LCD of claim 5, further comprising a nonvolatile memory connected to the timing controller for nonvolatilely storing data representing a current dimming signal value.

7. The LCD of claim 6, wherein the memory includes an EEPROM and is disposed on the circuit substrate.

8. The LCD of claim 3 and further comprising a disconnectable transmission cable that is operatively connected to said first connector, the transmission cable having first conductors defining at least a second part of the first bidirectional channel where the first conductors are disconnectably connectable to the first part of the first bidirectional channel through the first connector, and the transmission cable having second conductors defining at least a second part of the first unidirectional channel where the second conductors are disconnectably connectable to the first part of the first unidirectional channel through the first connector, and where the transmission cable is thereby able to transmit to an external host device the OSD image-requesting control signal and to receive from the external host device the OSD video signal through use of the second part of the first bi-directional channel and the second part of the unidirectional channel.

9. A display system comprising:
an LCD monitor comprising a user input handling portion for providing a user command signal in response to user manipulation of user inputs, and a timing controller for receiving the user command signal and outputting a corresponding OSD image-requesting control signal, and receiving a corresponding OSD video signal; and
a host device adapted for receiving the OSD image-requesting control signal, and for providing the corresponding OSD video signal to the LCD monitor.

10. The display system of claim 9, further comprising a transmission cable connected to the LCD monitor and to the host device and adapted to transmit the OSD image-requesting control signal and the corresponding OSD video signal so that the LCD monitor can thereby request an OSD image from the host device and the host device can responsively provide the requested OSD image as the OSD video signal transmitted through the transmission cable.

11. The display system of claim 10, wherein the LCD monitor and host device interface with one another in accordance with the VESA DisplayPort standard.

12. The display system of claim 10, wherein the LCD monitor further comprises a circuit substrate having a first bi-directional channel, a first unidirectional channel, and a first connector disposed thereon,
the circuit substrate further having a timing controller disposed thereon, where the timing controller is connected to the first connector through the first bi-directional channel and the first unidirectional channel,
wherein the transmission cable is coupled to the first connector, and
wherein the timing controller outputs the OSD image-requesting control signal to the host device through the first bi-directional channel, and receives the corresponding OSD video signal from the host device through the first unidirectional channel.

13. The display system of claim 12, wherein the transmission cable comprises a second bi-directional channel connected to the first bidirectional channel and a second unidirectional channel connected to the first unidirectional channel, and
wherein when the host device further provides at least one of a video signal and an audio signal to the LCD monitor via the second unidirectional channel;
wherein the LCD monitor transmits the OSD image-requesting control signal to the host device through the second bi-directional channel, and
wherein the LCD monitor receives at least one of the video signal and the audio signal from the host device through the second unidirectional channel.

14. The display system of claim 12, wherein the circuit substrate further comprises a second connector, and
the handling portion provides the user command signal to the timing controller through the second connector.

15. The display system of claim 14, further comprising:
a backlight unit for generating light; and
an inverter connected to the second connector to receive a dimming signal and connected to the backlight unit to control a brightness of the backlight unit,
wherein the timing controller provides the dimming signal to the inverter through the second connector in a manner corresponding to the user command signal.

16. The display system of claim 15, further comprising a memory connected to the timing controller and storing data representing a last used value of the dimming signal.

17. The display system of claim 16, wherein the memory is an EEPROM and is disposed on the circuit substrate.

18. The display system of claim 14, wherein the LCD monitor further comprises an internal module and a memory connected to the timing controller,
the timing controller providing to the internal module a module control signal for controlling operation of the internal module in response to the user command signal, and storing data representing the module control signal in the memory.
